(19) United States
(12) Patent Application Publication
(10) Pub. No.: US 2007/0086825 A1
(43) Pub. Date: Apr. 19, 2007

(54) Circular keyboard

(76) Inventor: Byung Kon Min, Palo Alto, CA (US)

Correspondence Address: Byung Kon Min, 890 Los Robles Ave, Palo Alto, CA, 94306, US

(21) Appl. No.: 11/581,303

(22) Filed: Oct. 16, 2006

Related U.S. Application Data
(60) Provisional application No. 60/726,932, filed on Oct. 15, 2005.
(60) Provisional application No. 60/777,069, filed on Feb. 27, 2006.

(51) Int. Cl. B41J 5/00

(52) U.S. Cl. 400/472

(57) ABSTRACT

A generic circular keyboard 101 comprised of double concentric circles of switches 1-24 are arranged in a configuration that substantially follows the geometry of a clock face, i.e. 30 degree angular spacing. The adjacent pairs of concentric switches, 1 and 13, 2 and 14, etc. are implemented each as a 2-way rocker switch. Additionally, the center circle is implemented as a 4-way rocker switch 25-28 with 90 degree angular spacing. Said generic circular keyboard arrangement is situated within a tangential square that provides four additional switch locations 29-34, one at each corner. Said keyboard substantially doubles the number of generic key functions each time an on/off mode switch function is incorporated, i.e. 24, 48, 96, 192, etc. or 28, 56, 112, 224, etc.

### CROSS-REFERENCE TO RELATED APPLICATIONS

This application claims the benefit of provisional applications “Circular Keyboard,” Ser. No. 60/726932 filed on Oct. 15, 2005 and “Remote Input Device,” Ser. No. 60/777069 filed on Feb. 27, 2006, both by the present inventor.

### FEDERALLY SPONSORED RESEARCH

Not Applicable

### SEQUENCE LISTING OF PROGRAM

Not Applicable

### BACKGROUND OF INVENTION—FIELD OF THE INVENTION

The present invention relates to data entry keyboards for electronic instruments: more particularly a space efficient, easy-to-use hand-held keyboard for small electronic devices, mobile phones, computers, and Internet TVs.

### BACKGROUND OF THE INVENTION—PRIOR ART

The conventional keyboard for handheld electronic devices, such as mobile phones and personal digital assistants (PDAs), primarily uses numeric keys arranged in rows and columns. Typically, the same keys also provide input functions for alphabet letters when stroked multiple times. For example, most phones have keypads where the number 2 key is also used to type alphabet letters A, B, and C if stroked rapidly once, twice, and thrice, respectively, when in the alphabet mode. Thus, the number of key strokes one must apply to obtain a particular alphabet letter is two or more on the average. This is acceptable only for occasional use but too cumbersome for frequent use. To reduce the number of strokes in typing alphabet letters and other symbols, an increased number of keys are required. The need to place additional keys in a small footprint is increasing as devices become more sophisticated and more and more functions are built in.

The need for remote entry of full alpha-numeric data is increasing as the Internet and Internet Protocol TVs are fast becoming the preferred mode of entertainment delivery. More and more PCs are used for multi-media entertainments. Data entry and commands for PCs are usually performed by using full size keyboards. To find entertainment content from the Internet and watch them on a computer monitor from distance, a hand held, compact keyboard that can perform the data entry and commands remotely becomes increasingly necessary.

A full function data entry device typically consists of a QWERTY keyboard, a numeric keypad, dedicated and programmable function keys, and cursor control keys. An on-screen pointer control means, such as a remote mouse or a button or touch pad integrated with the keyboard, is also provided. Various accessories, including mouse pads and wrist rests, are typically positioned on the work surface proximate to the keyboard. For the aforementioned hand-held devices, however, the placement of any full alphanumeric keyboards such as the standard QWERTY keyboards along with numeric keypads is prohibitive because of the size limit.

### BACKGROUND OF THE INVENTION—OBJECTS AND ADVANTAGES

It is the objective of the present invention to provide the users of small hand held electronic devices, such as PC remote controls, mobile phones, and personal digital assistants (PDAs), with single handed means of data entry,

It is the objective of the present invention to incorporate substantially the full size keyboard functionality in said small devices,

It is the objective of the present invention to minimize the number of strokes for data entry for said small devices,

It is the objective of the present invention to meet the need for remote access means to the Internet and Internet Protocol TVs that are fast becoming the preferred mode of entertainment delivery,

It is the advantage of the present invention that the key arrangement is compact and yet the number of available key functions is comparable to that of full size keyboards such as the standard QWERTY keyboard,

It is the advantage of the present invention that the key locations are easily remembered for anyone who is already familiar with the clock face,

It is the advantage of the present invention that the key arrangement is compact and yet the keys are still easily accessible by the implementation of a 2-way and 4-way rocker switches,

It is the advantage of the present invention that the number of key strokes required to obtain alphabet letters is significantly less than required by most other hand held keyboards such as those of the AT&T phones.

### SUMMARY OF THE INVENTION

In accordance with the present invention, a generic circular keyboard is comprised of double concentric circles of switches arranged in a configuration that substantially follows the geometry of a clock face, i.e. 30 degree angular spacing.

### BRIEF DESCRIPTION OF THE DRAWINGS

FIG. 1 shows the key locations numbered from 1 to 32 in an embodiment of the present invention: 24 keys in the double concentric circles, four in the center circle, and additional four with each at each corner within a tangential square,

FIG. 2 shows each of an adjacent pair of concentric switches, represented by key 2 and key 14, implementing as a 2-way rocker switch,

FIG. 3 shows an embodiment of the present invention listing the symbols that can be typed by the keys 1 through 28 with the key 29 (the num lock key) and key 31 (shift key) in four way combination of on and off,

FIG. 4 shows an alphanumeric circular keyboard with the symbols marked on the face of each key according to the list shown in FIG. 3,

FIG. 5 shows a circular alphanumeric keyboard with the English alphabet placed substantially following the traditional QWERTY keyboard except each row or each adjacent pair is folded into two and the numerals from 0 to 9 and * and # symbols are placed along the concentric circles from 11 o'clock direction to 1 o'clock direction substantially following the layout of the traditional numeric key pad of the QWERTY keyboard.

FIG. 6 shows a circular alphanumeric keyboard with the 14 consonant symbols of the 24 Korean Hangeul alphabets placed substantially from 6 o'clock to 12 o'clock directions and the remaining 10 vowel symbols are placed substantially from 1 o'clock to 5 o'clock directions.

FIG. 7 shows an embodiment of the present keyboard on a cell phone,

FIG. 8 shows an embodiment of the present keyboard on a remote controller of computers showing the 32 keys of the present invention and additional functional keys including ctrl, space, alt, esc, tab, insert, del, up arrow, down arrow, left arrow, right arrow, and mouse mode, etc.

### DETAILED DESCRIPTION OF THE INVENTION

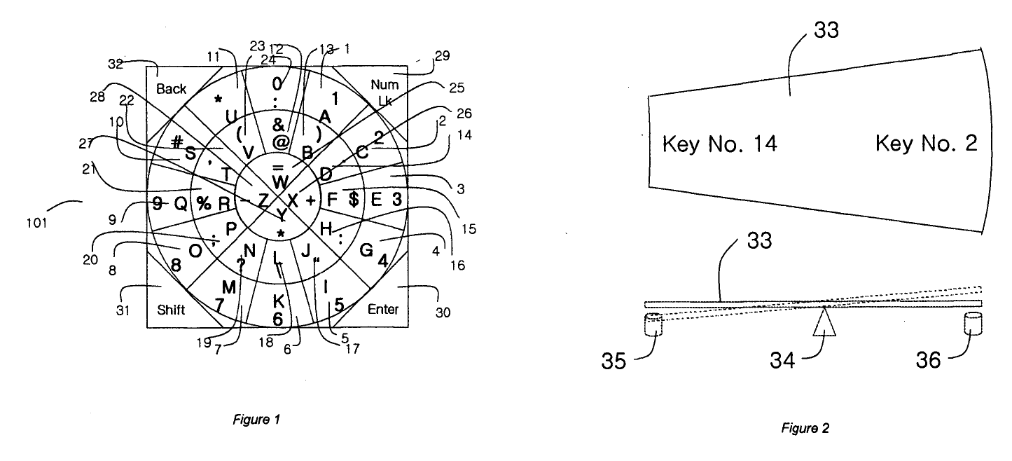

FIG. 1 shows the preferred embodiment of the present invention with 34 key locations: 24 keys in the double concentric circles, four in the center circle, and additional four with each at each corner within a tangential square. The double concentric circle keys are numbered from 1 to 24, the center circle keys are numbered from 25 to 28 and the four corner keys are numbered from 29 to 32.

The generic circular keyboard is comprised of double concentric circles of switches and arranged in a configuration that substantially follows the geometry of a clock face, i.e. 30 degree angular spacing. Said keyboard increases the number of generic key functions substantially in multiples of 12, i.e. 24, 48, 96, 192, etc. by incorporating additional on/off mode switches.

Four additional key(s) are placed at the center circle with each key separated by 90 degrees angularly. With the use of additional on/off mode switches, the center keys add generic key functions by 4, 8, 16, 32, etc.

The numerals from 0 to 9 are placed along one of the circles substantially following the layout of clock numerals, and the alphabets, or the symbols of the writing systems of any language, are placed over double concentric circles and the center circle.

Said generic circular keyboard arrangement is situated within a tangential square that provides four additional switch locations, one at each corner. The total number of keys available for this embodiment is 32. Keys 1 and 13 are in one o'clock direction, keys 2 and 14 are in two o'clock direction and so on and finally keys 12 and 24 are in the 12 o'clock direction.

Four additional key(s) 29-32 are placed at each corner within a tangential square. In this embodiment, two of the four corner keys are used as on/off mode switches, i.e., the number lock key and the shift key. These are then used to multiply the available functions of alphanumeric keys by two times, four times, etc., depending on the mode created by the available combinations of the modes.

FIG. 2 shows an adjacent pair of concentric switches, represented by key 2 and key 14, implementing as a 2-way rocker switch. Any two keys located along the same radius and on adjacent circles are rigidly joined together 33 and mechanically supported in the middle by a fulcrum 34 such that each end of the joined key is movable in seesaw rocking motion when pressed substantially on the inner circle and on the outer circle, respectively. The key then close the circuitry by making contact with a conductive end of the circuit 35 or 36. The four center keys 25, 26, 27, and 28 are rigidly joined together and mechanically supported at the center such that each corner of the joined key is movable in four ways, 90 degree apart, seesaw rocking motion when pressed substantially on the outer circle.

The use of seesaw rocking motion keys minimizes the number of mechanical components, thus increasing mechanical reliability, simplifying the manufacture of the device while increasing the user friendliness and ergonomics. For instance, keys No. 1 and 13 may be constructed by one two-way rocker key. Likewise, keys No. 2 and 14, etc. The centrally located keys No. 25, 26, 27, and 28 are constructed by use of one four-way 4-way rocker switch with 90 degree angular spacing.

Without reducing the total number of key functions, the actual number of keys in this embodiment may be reduced from 32 to only 17 (12 circularly placed keys plus one centrally placed plus four at outer corners).

The clock face placement of numerals is graphically known to most people and is well known to the art. For example, U.S. Pat. No. 5,701,123, U.S. Pat. No. 6,173,194, U.S. Pat. No. 6,925,315, U.S. Pat. No. 6,954,355. By placing both the numerals and alphabets in such an arrangement, one gains two major benefits: (1) one can more easily remember the locations of numerals and alphabet letters as the arrangement substantially follows that of a clock, the geometry of which is already familiar to most people, (2) the key arrangement is compact and permits placement of a large number of alphanumeric characters in a relatively small space than most existing hand held devices.

Although the clock face arrangement of numeric keys are available from many prior arts, the use of the same geometry in double concentric circles combined with on/off mode switches provide the users with available keys in the multiples of 24, i.e., 24, 48, 96 etc.

In the center of the keypad is another circle which is divided into only four or less to maintain the key size to be as compatible as the finger tip size of an ordinary person. Additional keys are placed outside the outermost circle and inside the square whose four edges is tangential to said outermost circle, respectively, and in the corner spaces created by them. These four corners are usually available for most devices that are of a rectangular or square shape.

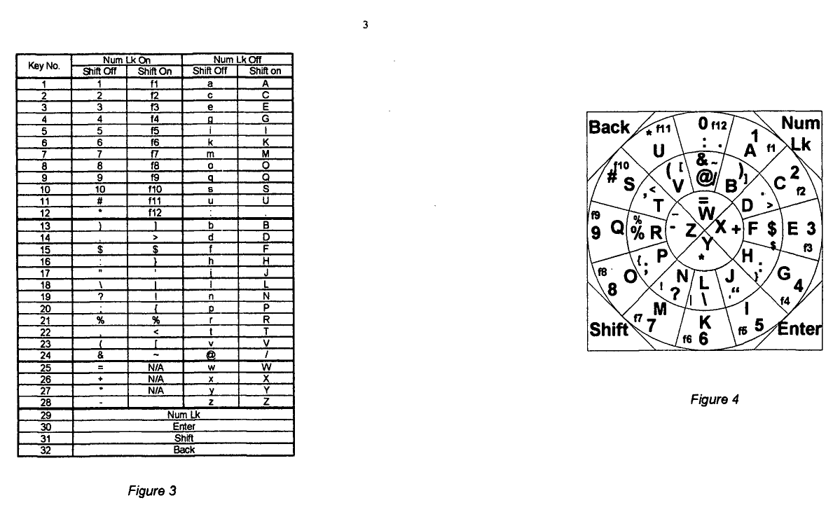

FIG. 3 lists the representative alphanumeric symbols assigned to each of the 32 keys when the number lock key and the shift key are turned on or off, respectively.

If the number lock key (Key No. 29) is pressed once, the internal switch is actuated such that the remaining keys function as numeric and related keys. If this key is pressed again, then the keys function as alphabet and related keys.

If the shift key (Key No. 31) is pressed once, the remaining keys provide one set of alphanumeric letters, such as upper case letters of English alphabet. If this same key is pressed again, then the function returns and one obtains another ser of the alphanumeric letters, such as lower case English alphabet.

Thus the total number of available symbols are 112, i.e., 28 (32 minus num lock key minus shift key minus two additional function keys) times 4 equals 112. This number is sufficient for most alphanumeric data entry, comparable to that of the full QWERTY alphanumeric keyboard.

The inventive feature of this invention is the use of plurality of concentric circles and the familiar clock face layout for each circle to create a maximum number of keys, resulting in a novel, fully populated keyboard in a relatively small space, with maximum usage of space such that the size of each key is still acceptable for average size fingers to touch, feel, and press for data entry.

The inventive feature of this invention is the use of additional mode keys such as number lock key and shift key, thus depending on the number of such switches providing 2, 4, or 8 times of the actual number of keys as the total number of available key functions, i.e., 48, 96, 192, etc.

The inventive feature of this invention is the use of two way- or four way-rocking motion keys to minimize the number of mechanical components, thus increasing mechanical reliability; simplifying the manufacture of the device, while increasing the user friendliness and ergonomic effect.

FIGS. 4-6 shows representative symbols assigned to the keyboard of the present invention.

In FIG. 4, 22 of 26 English alphabet letters are placed along double concentric circles from 1 o'clock to 11 o'clock directions and the remaining 4 in the center circle in 3 o'clock, 6 o'clock, 9 o'clock, and 12 o'clock directions with the numerals from 0 to 9 and * and # symbols placed along one of the circles substantially following the layout of a clock face from 12 o'clock direction to 11 o'clock direction in the clockwise order.

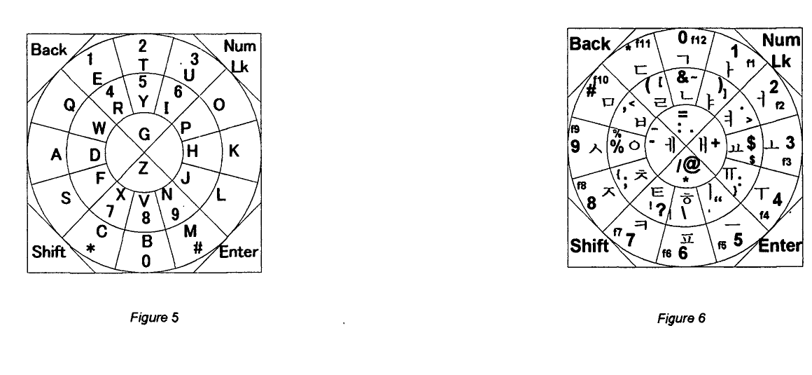

In FIGS. 5, an alphanumeric keyboard places the English alphabet substantially following the traditional QWERTY keyboard except each row or each adjacent pair is folded into two and the numerals from 0 to 9 and * and # symbols are placed along plurality of circles from 11 o'clock direction to 1 o'clock direction substantially following the layout of the traditional numeric key pad of the QWERTY keyboard.

In FIG. 6, an alphanumeric keyboard places 14 consonant symbols of the 24 Korean Hangeul alphabets substantially from 6 o'clock to 12 o'clock directions and the remaining 10 vowel symbols substantially from 1 o'clock to 5 o'clock directions.

The invention is not intended to be limited to the particular arrangements of symbols discussed above as examples and shown in the drawings, but also encompasses reasonable modifications and equivalents within the scope of the appended claims, which define the scope of exclusive rights that are claimed.

Additional keys may be placed outside this 32 key footprint for more key functions and as needed by any specific applications and as footprint space permits.

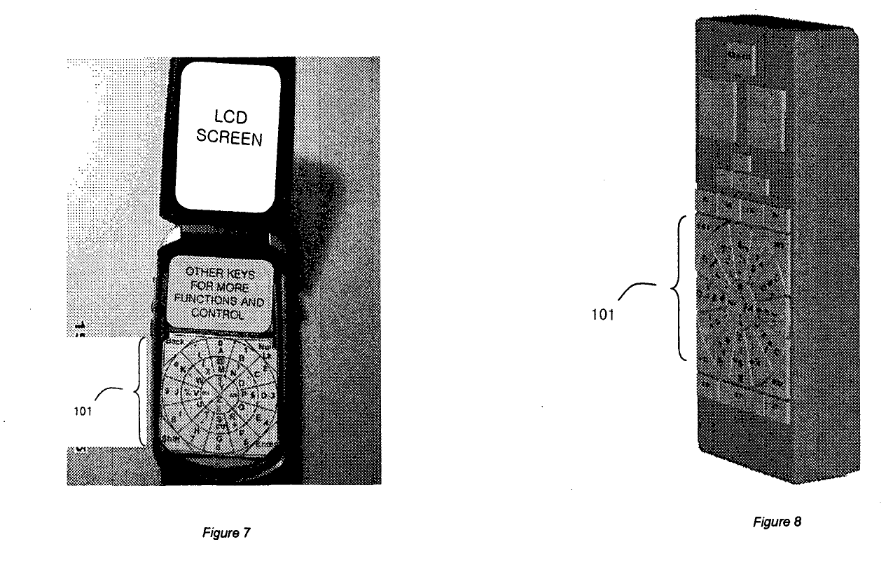

FIG. 7 shows a representative application of the present invention to cell phones with the generic keyboard of the present invention 101 providing most of the key functions and more keys are added in any available space as needed.

FIG. 8 shows a representative application of the present invention to remote controllers with the generic keyboard of the present invention 101 providing most of the key functions and more keys are added in any available space as needed.

What is claimed are:

1. A generic circular keyboard comprised of double concentric circles of switches are arranged in a configuration that substantially follows the geometry of a clock face, i.e. 30 degree angular spacing.

2. A generic circular keyboard arrangement of claim 1 that implements adjacent pairs of concentric switches, each as a 2-way rocker switch

3. A generic circular keyboard arrangement of claim 1 that includes a generic switch in the central location.

4. A generic circular keyboard arrangement of claim 1 that includes a 4-way rocker switch in the central location.

5. A generic circular keyboard arrangement of claims 1 and 3 that is situated within a tangential square that provides four additional switch locations, one at each corner.

6. A generic circular keyboard of claims 1, 3, and 5 that incorporate additional, two way (i.e., position 1 and position 2) functional keys, to increase the number of generic key functions in multiples of 24, i.e. 24, 48, 96, 192, etc.

7. A circular keyboard of claims 1, 3, and 5 with an alphanumeric keyboard such that 22 of 26 English alphabet letters are placed along double concentric circles from 1 o'clock to 11 o'clock directions and the remaining 4 in the center circle in 3 o'clock, 6 o'clock, 9 o'clock, and 12 o'clock directions with the numerals from 0 to 9 and * and # symbols placed along one of the circles substantially following the layout of a clock face from 12 o'clock direction to 11 o'clock direction in the clockwise order.

8. A circular keyboard of claims 1, 3, and 5 with an alphanumeric keyboard with the English alphabet placed substantially following the traditional QWERTY keyboard except each row or each pair is folded into two and the numerals from 0 to 9 and * and # symbols are placed along plurality of circles from 11 o'clock direction to 1 o'clock direction substantially following the layout of the traditional numeric key pad of the QWERTY keyboard.

9. A circular keyboard of claims 1, 3, and 5 with an alphanumeric keyboard with the 14 consonant symbols of the 24 Korean Hangeul alphabets placed substantially from 6 o'clock to 12 o'clock directions and the remaining 10 vowel symbols are placed substantially from 1 o'clock to 5 o'clock direction
